(19) United States
(12) Patent Application Publication
(10) Pub. No.: US 2010/0082427 A1
(43) Pub. Date: Apr. 1, 2010

(54) System and Method for Context Enhanced Ad Creation

(75) Inventors: Carrie Amanda Burgener, Berkeley, CA (US); Simon Peter King, Berkeley, CA (US); Christopher Todd Paretti, San Francisco, CA (US); Chris W. Higgins, Portland, OR (US); Marc Davis, San Francisco, CA (US); Athellina Athsani, San Jose, CA (US); Rahul Nair, Sunnyvale, CA (US); Nathanael Joe Hayashi, Piedmont, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 12/242,656

(22) Filed: Sep. 30, 2008

(51) Int. Cl. G06Q 30/00

(52) U.S. Cl. 705/14.49

(57) ABSTRACT

Methods, apparatuses and systems directed to creating contextually-targeted advertisements. In a particular implementation, advertisers may leverage a W4 COMN to deliver contextually-targeted and/or contextually-enhanced advertisements. In the implementations discussed below, an ad creation system utilizes data made available by the W4 COMN to facilitate the creation and placement of advertisements on a message delivery network, such as the W4 COMN itself.

### FIELD OF THE INVENTION

The present disclosure generally relates to systems and methods for creating contextually-targeted ads on a network.

### BACKGROUND OF THE INVENTION

A great deal of information is generated when people use electronic devices, such as when people use mobile phones and cable set-top boxes. Such information, such as location, applications used, social network, physical and online locations visited, to name a few, could be used to deliver useful services and information to end users, and provide commercial opportunities to advertisers and retailers. However, most of this information is effectively abandoned due to deficiencies in the way such information can be captured. For example, and with respect to a mobile phone, information is generally not gathered while the mobile phone is idle (i.e., not being used by a user). Other information, such as presence of others in the immediate vicinity, time and frequency of messages to other users, and activities of a user's social network are also not captured or utilized effectively.

### SUMMARY OF THE INVENTION

The present invention provides methods, apparatuses and systems directed to creating contextually-targeted advertisements. In a particular implementation, advertisers may leverage a W4 COMN to deliver contextually-targeted and/or contextually-enhanced advertisements. In the implementations discussed below, an ad creation system utilizes data made available by the W4 COMN to facilitate the creation and placement of advertisements on a message delivery network, such as the W4 COMN itself. Ad creation typically involves the identification of ad content, including text and media objects, as well as targeting and delivery parameters. As discussed in more detail below, implementations of the invention are directed to utilizing contextual W4 metadata to facilitate one or more aspects of ad creation.

### BRIEF DESCRIPTION OF THE DRAWINGS

The foregoing and other objects, features, and advantages of the invention will be apparent from the following more particular description of preferred embodiments as illustrated in the accompanying drawings, in which reference characters refer to the same parts throughout the various views. The drawings are not necessarily to scale, emphasis instead being placed upon illustrating principles of the invention.

FIG. 1 illustrates relationships between real-world entities (RWE) and information objects (IO) on one embodiment of a W4 Communications Network (W4 COMN.)

FIG. 2 illustrates metadata defining the relationships between RWEs and IOs on one embodiment of a W4 COMN.

FIG. 3 illustrates a conceptual model of one embodiment of a W4 COMN.

FIG. 4 illustrates the functional layers of one embodiment of the W4 COMN architecture.

FIG. 5 illustrates the analysis components of one embodiment of a W4 engine as shown in FIG. 2.

FIG. 6 illustrates one embodiment of a W4 engine showing different components within the sub-engines shown in FIG. 5.

FIG. 7 illustrates one embodiment of a data model showing how a W4 COMN can store media files and relate such files to RWEs, such as persons and places, and IOs, such as topics and other types of metadata.

FIG. 8 illustrates one embodiment of a system capable of supporting context-enhanced messaging between users known to a network.

FIG. 9 illustrates one embodiment of a process of how a network containing temporal, spatial, and social network and topical data for a plurality of users, devices, and media, such as a W4 COMN, can be used to enable ad messages having complex delivery and targeting criteria.

FIG. 10 illustrates one embodiment of an ad message engine capable of supporting the process illustrated in FIG. 9.

FIG. 11 sets forth a process flow, according to one possible embodiment of the invention, directed to facilitating creation of ads.

### DETAILED DESCRIPTION

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions.

These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

For the purposes of this disclosure the term “end user” or “user” should be understood to refer to a consumer of data supplied by a data provider. By way of example, and not limitation, the term “end user” can refer to a person who receives data provided by the data provider over the Internet in a browser session, or can refer to an automated software application which receives the data and stores or processes the data.

For the purposes of this disclosure the term “media” and “media content” should be understood to refer to binary data which contains content which can be of interest to an end user. By way of example, and not limitation, the term “media” and “media content” can refer to multimedia data, such as video data or audio data, or any other form of data capable of being transformed into a form perceivable by an end user. Such data can, furthermore, be encoded in any manner currently known, or which can be developed in the future, for specific purposes. By way of example, and not limitation, the data can be encrypted, compressed, and/or can contained embedded metadata.

For the purposes of this disclosure, a computer readable medium stores computer data in machine readable form. By way of example, and not limitation, a computer readable medium can comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other mass storage devices, or any other medium which can be used to store the desired information and which can be accessed by the computer.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may grouped into an engine or an application.

For the purposes of this disclosure an engine is a software, hardware, or firmware (or combinations thereof) system, process or functionality that performs or facilitates the processes, features, and/or functions described herein (with or without human interaction or augmentation).

Embodiments of the present invention utilize information provided by a network which is capable of providing data collected and stored by multiple devices on a network. Such information may include, without limitation, temporal information, spatial information, and user information relating to a specific user or hardware device. User information may include, without limitation, user demographics, user preferences, user social networks, and user behavior. One embodiment of such a network is a W4 Communications Network.

A “W4 Communications Network” or W4 COMN, provides information related to the “Who, What, When and Where” of interactions within the network. In one embodiment, the W4 COMN is a collection of users, devices and processes that foster both synchronous and asynchronous communications between users and their proxies providing an instrumented network of sensors providing data recognition and collection in real-world environments about any subject, location, user or combination thereof.

In one embodiment, the W4 COMN can handle the routing/addressing, scheduling, filtering, prioritization, replying, forwarding, storing, deleting, privacy, transacting, triggering of a new message, propagating changes, transcoding and/or linking. Furthermore, these actions can be performed on any communication channel accessible by the W4 COMN.

In one embodiment, the W4 COMN uses a data modeling strategy for creating profiles for not only users and locations, but also any device on the network and any kind of user-defined data with user-specified conditions. Using Social, Spatial, Temporal and Logical data available about a specific user, topic or logical data object, every entity known to the W4 COMN can be mapped and represented against all other known entities and data objects in order to create both a micro graph for every entity as well as a global graph that relates all known entities with one another. In one embodiment, such relationships between entities and data objects are stored in a global index within the W4 COMN.

In one embodiment, a W4 COMN network relates to what may be termed “real-world entities”, hereinafter referred to as RWEs. A RWE refers to, without limitation, a person, device, location, or other physical thing known to a W4 COMN. In one embodiment, each RWE known to a W4 COMN is assigned a unique W4 identification number that identifies the RWE within the W4 COMN.

RWEs can interact with the network directly or through proxies, which can themselves be RWEs. Examples of RWEs that interact directly with the W4 COMN include any device such as a sensor, motor, or other piece of hardware connected to the W4 COMN in order to receive or transmit data or control signals. RWE may include all devices that can serve as network nodes or generate, request and/or consume data in a networked environment or that can be controlled through a network. Such devices include any kind of “dumb” device purpose-designed to interact with a network (e.g., cell phones, cable television set top boxes, fax machines, telephones, and radio frequency identification (RFID) tags, sensors, etc.).

Examples of RWEs that may use proxies to interact with W4 COMN network include non-electronic entities including physical entities, such as people, locations (e.g., states, cities, houses, buildings, airports, roads, etc.) and things (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) may be considered RWE that use proxies to interact with the network, where software applications executing on the device that serve as the devices' proxies.

In one embodiment, a W4 COMN may allow associations between RWEs to be determined and tracked. For example, a given user (an RWE) can be associated with any number and type of other RWEs including other people, cell phones, smart credit cards, personal data assistants, email and other communication service accounts, networked computers, smart appliances, set top boxes and receivers for cable television and other media services, and any other networked device. This association can be made explicitly by the user, such as when the RWE is installed into the W4 COMN.

An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association can include the user identifying a specific relationship between the user and the RWE (e.g., this is my device, this is my home appliance, this person is my friend/father/son/etc., this device is shared between me and other users, etc.). RWEs can also be implicitly associated with a user based on a current situation. For example, a weather sensor on the W4 COMN can be implicitly associated with a user based on information indicating that the user lives or is passing near the sensor's location.

In one embodiment, a W4 COMN network may additionally include what may be termed “information-objects”, hereinafter referred to as IOs. An information object (IO) is a logical object that may store, maintain, generate or otherwise provides data for use by RWEs and/or the W4 COMN. In one embodiment, data within in an IO can be revised by the act of an RWE An IO within in a W4 COMN can be provided a unique W4 identification number that identifies the IO within the W4 COMN.

In one embodiment, IOs include passive objects such as communication signals (e.g., digital and analog telephone signals, streaming media and interprocess communications), advertisements, email messages, transaction records, virtual cards, event records (e.g., a data file identifying a time, possibly in combination with one or more RWEs such as users and locations, that can further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In one embodiment, IOs include any executing process or application that consumes or generates data such as an email communication application (such as OUTLOOK by MICROSOFT, or YAHOO! MAIL by YAHOO!), a calendaring application, a word processing application, an image editing application, a media player application, a weather monitoring application, a browser application and a web page server application. Such active IOs can or can not serve as a proxy for one or more RWEs. For example, voice communication software on a smart phone can serve as the proxy for both the smart phone and for the owner of the smart phone.

In one embodiment, for every IO there are at least three classes of associated RWEs. The first is the RWE that owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs that access the IO in order to obtain data from the IO for some purpose.

Within the context of a W4 COMN, “available data” and “W4 data” means data that exists in an IO or data that can be collected from a known IO or RWE such as a deployed sensor. Within the context of a W4 COMN, “sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

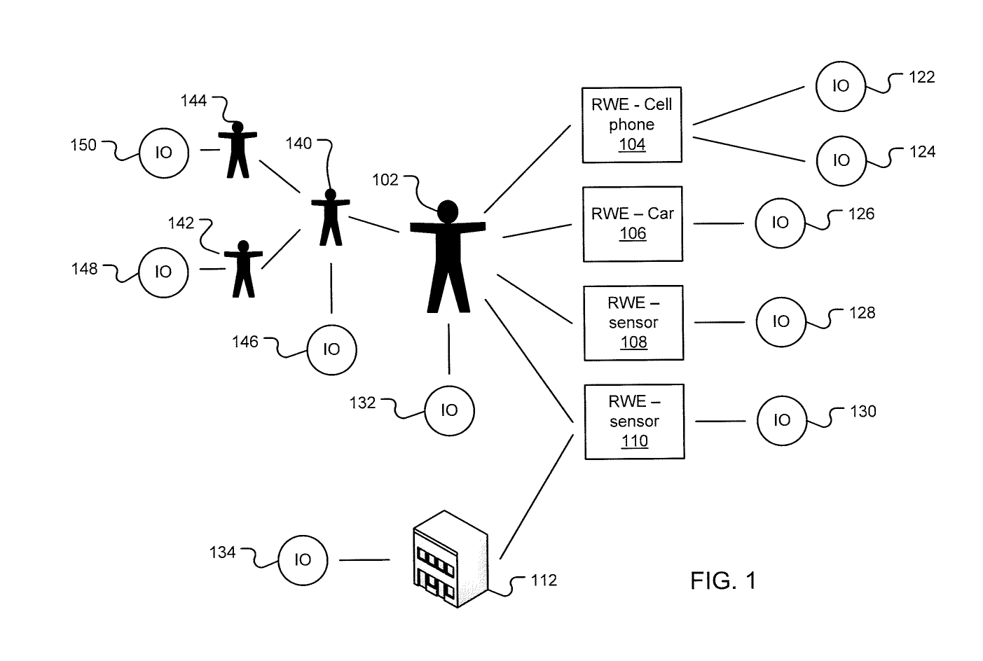

FIG. 1 illustrates one embodiment of relationships between RWEs and IOs on a W4 COMN. A user 102 is a RWE provided with a unique network ID. The user 102 may be a human that communicates with the network using proxy devices 104, 106, 108, 110 associated with the user 102, all of which are RWEs having a unique network ID. These proxies can communicate directly with the W4 COMN or can communicate with the W4 COMN using IOs such as applications executed on or by a proxy device.

In one embodiment, the proxy devices 104, 106, 108, 110 can be explicitly associated with the user 102. For example, one device 104 can be a smart phone connected by a cellular service provider to the network and another device 106 can be a smart vehicle that is connected to the network. Other devices can be implicitly associated with the user 102.

For example, one device 108 can be a “dumb” weather sensor at a location matching the current location of the user's cell phone 104, and thus implicitly associated with the user 102 while the two RWEs 104, 108 are co-located. Another implicitly associated device 110 can be a sensor 110 for physical location 112 known to the W4 COMN. The location 112 is known, either explicitly (through a user-designated relationship, e.g., this is my home, place of employment, parent, etc.) or implicitly (the user 102 is often co-located with the RWE 112 as evidenced by data from the sensor 110 at that location 112), to be associated with the first user 102.

The user 102 can be directly associated with one or more persons 140, and indirectly associated with still more persons 142, 144 through a chain of direct associations. Such associations can be explicit (e.g., the user 102 can have identified the associated person 140 as his/her father, or can have identified the person 140 as a member of the user's social network) or implicit (e.g., they share the same address). Tracking the associations between people (and other RWEs as well) allows the creation of the concept of “intimacy”, where intimacy may be defined as a measure of the degree of association between two people or RWEs. For example, each degree of removal between RWEs can be considered a lower level of intimacy, and assigned lower intimacy score. Intimacy can be based solely on explicit social data or can be expanded to include all W4 data including spatial data and temporal data.

In one embodiment, each RWE 102, 104, 106, 108, 110, 112, 140, 142, 144 of a W4 COMN can be associated with one or more IOs as shown. FIG. 1 illustrates two IOs 122, 124 as associated with the cell phone device 104. One IO 122 can be a passive data object such as an event record that is used by scheduling/calendaring software on the cell phone, a contact IO used by an address book application, a historical record of a transaction made using the device 104 or a copy of a message sent from the device 104. The other IO 124 can be an active software process or application that serves as the device's proxy to the W4 COMN by transmitting or receiving data via the W4 COMN. Voice communication software, scheduling/calendaring software, an address book application or a text messaging application are all examples of IOs that can communicate with other IOs and RWEs on the network. IOs may additionally relate to topics of interest to one or more RWEs, such topics including, without limitation, musical artists, genre of music, a location and so forth.

The IOs 122, 124 can be locally stored on the device 104 or stored remotely on some node or data store accessible to the W4 COMN, such as a message server or cell phone service datacenter. The IO 126 associated with the vehicle 108 can be an electronic file containing the specifications and/or current status of the vehicle 108, such as make, model, identification number, current location, current speed, current condition, current owner, etc. The IO 128 associated with sensor 108 can identify the current state of the subject(s) monitored by the sensor 108, such as current weather or current traffic. The IO 130 associated with the cell phone 110 can be information in a database identifying recent calls or the amount of charges on the current bill.

RWEs which can only interact with the W4 COMN through proxies, such as people 102, 140, 142, 144, computing devices 104, 106 and locations 112, can have one or more IOs 132, 134, 146, 148, 150 directly associated with them which contain RWE-specific information for the associated RWE. For example, IOs associated with a person 132, 146, 148, 150 can include a user profile containing email addresses, telephone numbers, physical addresses, user preferences, identification of devices and other RWEs associated with the user. The IOs may additionally include records of the user's past interactions with other RWEs on the W4 COMN (e.g., transaction records, copies of messages, listings of time and location combinations recording the user's whereabouts in the past), the unique W4 COMN identifier for the location and/or any relationship information (e.g., explicit user-designations of the user's relationships with relatives, employers, co-workers, neighbors, service providers, etc.).

Another example of IOs associated with a person 132, 146, 148, 150 includes remote applications through which a person can communicate with the W4 COMN such as an account with a web-based email service such as Yahoo! Mail. A location's IO 134 can contain information such as the exact coordinates of the location, driving directions to the location, a classification of the location (residence, place of business, public, non-public, etc.), information about the services or products that can be obtained at the location, the unique W4 COMN identifier for the location, businesses located at the location, photographs of the location, etc.

In one embodiment, RWEs and IOs are correlated to identify relationships between them. RWEs and IOs may be correlated using metadata. For example, if an IO is a multimedia file corresponding to an ad, metadata for the file can include data identifying the advertiser, ad copy, etc., ad art, and the format of the multimedia data. This metadata can be stored as part of the file or in one or more different IOs that are associated with the file or both. W4 metadata can additionally include the owner of the media file and the rights the owner has in the media file. As another example, if the IO is a picture taken by an electronic camera, the picture can include in addition to the primary image data from which an image can be created on a display, metadata identifying when the picture was taken, where the camera was when the picture was taken, what camera took the picture, who, if anyone, is associated (e.g., designated as the camera's owner) with the camera, and who and what are the subjects of/in the picture. The W4 COMN uses all the available metadata in order to identify implicit and explicit associations between entities and data objects.

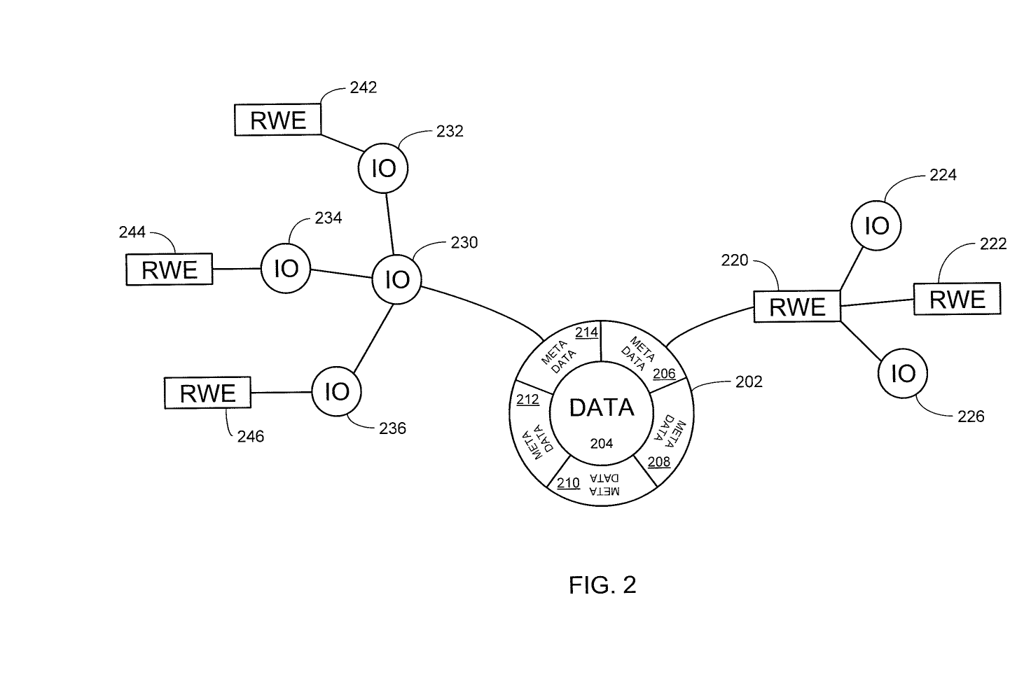

FIG. 2 illustrates one embodiment of metadata defining the relationships between RWEs and IOs on the W4 COMN. In the embodiment shown, an IO 202 includes object data 204 and five discrete items of metadata 206, 208, 210, 212, 214. Some items of metadata 208, 210, 212 can contain information related only to the object data 204 and unrelated to any other IO or RWE. For example, a creation date, text or an image that is to be associated with the object data 204 of the IO 202.

Some of items of metadata 206, 214, on the other hand, can identify relationships between the IO 202 and other RWEs and IOs. As illustrated, the IO 202 is associated by one item of metadata 206 with an RWE 220 that RWE 220 is further associated with two IOs 224, 226 and a second RWE 222 based on some information known to the W4 COMN. For example, could describe the relations between an image (IO 202) containing metadata 206 that identifies the electronic camera (the first RWE 220) and the user (the second RWE 224) that is known by the system to be the owner of the camera 220. Such ownership information can be determined, for example, from one or another of the IOs 224, 226 associated with the camera 220.

FIG. 2 also illustrates metadata 214 that associates the IO 202 with another IO 230. This IO 230 is itself associated with three other IOs 232, 234, 236 that are further associated with different RWEs 242, 244, 246. This part of FIG. 2, for example, could describe the relations between a music file (IO 202) containing metadata 206 that identifies the digital rights file (the first IO 230) that defines the scope of the rights of use associated with this music file 202. The other IOs 232, 234, 236 are other music files that are associated with the rights of use and which are currently associated with specific owners (RWEs 242, 244, 246).

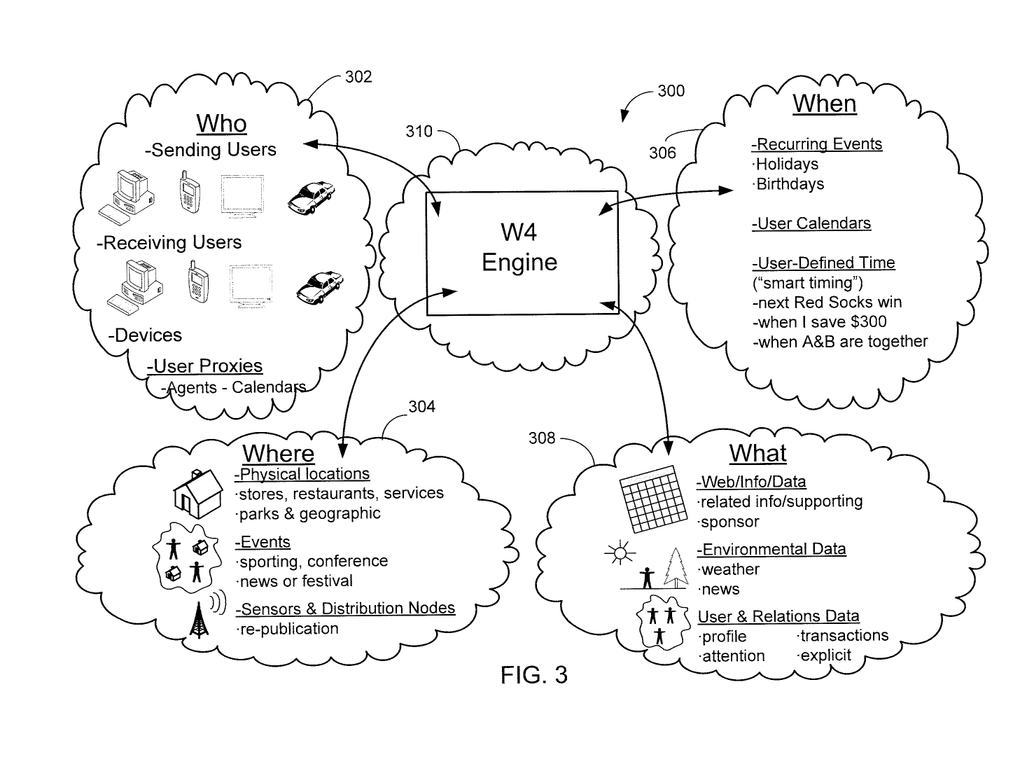

FIG. 3 illustrates one embodiment of a conceptual model of a W4 COMN. The W4 COMN 300 creates an instrumented messaging infrastructure in the form of a global logical network cloud conceptually sub-divided into networked-clouds for each of the 4Ws: Who, Where, What and When. In the Who cloud 302 are all users whether acting as senders, receivers, data points or confirmation/certification sources as well as user proxies in the forms of user-program processes, devices, agents, calendars, etc.

In the Where cloud 304 are all physical locations, events, sensors or other RWEs associated with a spatial reference point or location. The When cloud 306 is composed of natural temporal events (that is events that are not associated with particular location or person such as days, times, seasons) as well as collective user temporal events (holidays, anniversaries, elections, etc.) and user-defined temporal events (birthdays, smart-timing programs).

The What cloud 308 is comprised of all known data—web or private, commercial or user—accessible to the W4 COMN, including for example environmental data like weather and news, RWE-generated data, IOs and IO data, user data, models, processes and applications. Thus, conceptually, most data is contained in the What cloud 308.

Some entities, sensors or data may potentially exist in multiple clouds either disparate in time or simultaneously. Additionally, some IOs and RWEs can be composites in that they combine elements from one or more clouds. Such composites can be classified as appropriate to facilitate the determination of associations between RWEs and IOs. For example, an event consisting of a location and time could be equally classified within the When cloud 306, the What cloud 308 and/or the Where cloud 304.

In one embodiment, a W4 engine 310 is center of the W4 COMN's intelligence for making all decisions in the W4 COMN. The W4 engine 310 controls all interactions between each layer of the W4 COMN and is responsible for executing any approved user or application objective enabled by W4 COMN operations or interoperating applications. In an embodiment, the W4 COMN is an open platform with standardized, published APIs for requesting (among other things) synchronization, disambiguation, user or topic addressing, access rights, prioritization or other value-based ranking, smart scheduling, automation and topical, social, spatial or temporal alerts.

One function of the W4 COMN is to collect data concerning all communications and interactions conducted via the W4 COMN, which can include storing copies of IOs and information identifying all RWEs and other information related to the IOs (e.g., who, what, when, where information). Other data collected by the W4 COMN can include information about the status of any given RWE and IO at any given time, such as the location, operational state, monitored conditions (e.g., for an RWE that is a weather sensor, the current weather conditions being monitored or for an RWE that is a cell phone, its current location based on the cellular towers it is in contact with) and current status.

The W4 engine 310 is also responsible for identifying RWEs and relationships between RWEs and IOs from the data and communication streams passing through the W4 COMN. The function of identifying RWEs associated with or implicated by IOs and actions performed by other RWEs may be referred to as entity extraction. Entity extraction can include both simple actions, such as identifying the sender and receivers of a particular IO, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

It should be noted that when performing entity extraction from an IO, the IO can be an opaque object where only W4 metadata related to the object is visible, but internal data of the IO (i.e., the actual primary or object data contained within the object) are not, and thus metadata extraction is limited to the metadata. Alternatively, if internal data of the IO is visible, it can also be used in entity extraction, e.g. strings within an email are extracted and associated as RWEs to for use in determining the relationships between the sender, user, topic or other RWE or IO impacted by the object or process.

In the embodiment shown, the W4 engine 310 can be one or a group of distributed computing devices, such as general-purpose personal computers (PCs) or purpose built server computers, connected to the W4 COMN by communication hardware and/or software. Such computing devices can be a single device or a group of devices acting together. Computing devices can be provided with any number of program modules and data files stored in a local or remote mass storage device and local memory (e.g., RAM) of the computing device. For example, as mentioned above, a computing device can include an operating system suitable for controlling the operation of a networked computer, such as the WINDOWS XP or WINDOWS SERVER operating systems from MICROSOFT CORPORATION.

Some RWEs can also be computing devices such as, without limitation, smart phones, web-enabled appliances, PCs, laptop computers, and personal data assistants (PDAs). Computing devices can be connected to one or more communications networks such as the Internet, a publicly switched telephone network, a cellular telephone network, a satellite communication network, a wired communication network such as a cable television or private area network. Computing devices can be connected any such network via a wired data connection or wireless connection such as a wi-fi, a WiMAX (802.36), a Bluetooth or a cellular telephone connection.

Local data structures, including discrete IOs, can be stored on a computer-readable medium (not shown) that is connected to, or part of, any of the computing devices described herein including the W4 engine 310. For example, in one embodiment, the data backbone of the W4 COMN, discussed below, includes multiple mass storage devices that maintain the IOs, metadata and data necessary to determine relationships between RWEs and IOs as described herein.

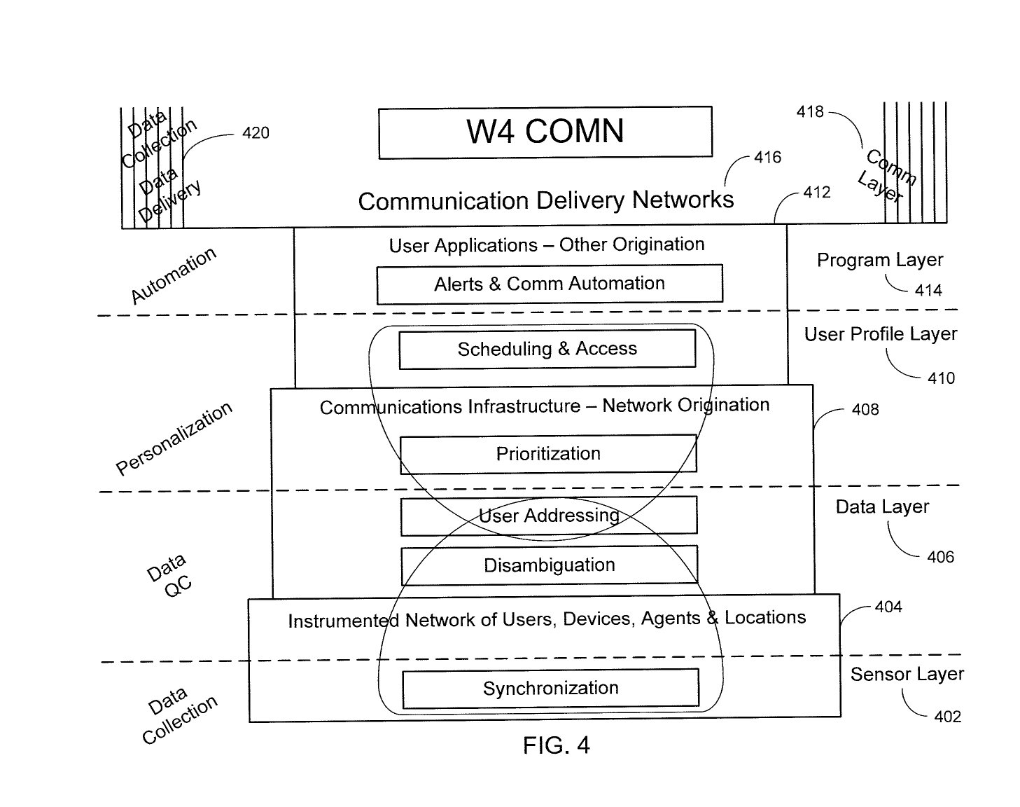

FIG. 4 illustrates one embodiment of the functional layers of a W4 COMN architecture. At the lowest layer, referred to as the sensor layer 402, is the network 404 of the actual devices, users, nodes and other RWEs. Sensors include known technologies like web analytics, GPS, cell-tower pings, use logs, credit card transactions, online purchases, explicit user profiles and implicit user profiling achieved through behavioral targeting, search analysis and other analytics models used to optimize specific network applications or functions.

The data layer 406 stores and catalogs the data produced by the sensor layer 402. The data can be managed by either the network 404 of sensors or the network infrastructure 406 that is built on top of the instrumented network of users, devices, agents, locations, processes and sensors. The network infrastructure 408 is the core under-the-covers network infrastructure that includes the hardware and software necessary to receive that transmit data from the sensors, devices, etc. of the network 404. It further includes the processing and storage capability necessary to meaningfully categorize and track the data created by the network 404.

The user profiling layer 410 performs the W4 COMN's user profiling functions. This layer 410 can further be distributed between the network infrastructure 408 and user applications/processes 412 executing on the W4 engine or disparate user computing devices. Personalization is enabled across any single or combination of communication channels and modes including email, IM, texting (SMS, etc.), photobloging, audio (e.g. telephone call), video (teleconferencing, live broadcast), games, data confidence processes, security, certification or any other W4 COMM process call for available data.

In one embodiment, the user profiling layer 410 is a logic-based layer above all sensors to which sensor data are sent in the rawest form to be mapped and placed into the W4 COMN data backbone 420. The data (collected and refined, related and deduplicated, synchronized and disambiguated) are then stored in one or a collection of related databases available applications approved on the W4 COMN. Network-originating actions and communications are based upon the fields of the data backbone, and some of these actions are such that they themselves become records somewhere in the backbone, e.g. invoicing, while others, e.g. fraud detection, synchronization, disambiguation, can be done without an impact to profiles and models within the backbone.

Actions originating from outside the network, e.g., RWEs such as users, locations, proxies and processes, come from the applications layer 414 of the W4 COMN. Some applications can be developed by the W4 COMN operator and appear to be implemented as part of the communications infrastructure 408, e.g. email or calendar programs because of how closely they operate with the sensor processing and user profiling layer 410. The applications 412 also serve as a sensor in that they, through their actions, generate data back to the data layer 406 via the data backbone concerning any data created or available due to the applications execution.

In one embodiment, the applications layer 414 can also provide a user interface (UI) based on device, network, carrier as well as user-selected or security-based customizations. Any UI can operate within the W4 COMN if it is instrumented to provide data on user interactions or actions back to the network. In the case of W4 COMN enabled mobile devices, the UI can also be used to confirm or disambiguate incomplete W4 data in real-time, as well as correlation, triangulation and synchronization sensors for other nearby enabled or non-enabled devices.

At some point, the network effects enough enabled devices to allow the network to gather complete or nearly complete data (sufficient for profiling and tracking) of a non-enabled device because of its regular intersection and sensing by enabled devices in its real-world location.

Above the applications layer 414, or hosted within it, is the communications delivery network 416. The communications delivery network can be operated by the W4 COMN operator or be independent third-party carrier service. Data may be delivered via synchronous or asynchronous communication. In every case, the communication delivery network 414 will be sending or receiving data on behalf of a specific application or network infrastructure 408 request.

The communication delivery layer 418 also has elements that act as sensors including W4 entity extraction from phone calls, emails, blogs, etc. as well as specific user commands within the delivery network context. For example, “save and prioritize this call” said before end of call can trigger a recording of the previous conversation to be saved and for the W4 entities within the conversation to analyzed and increased in weighting prioritization decisions in the personalization/user profiling layer 410.

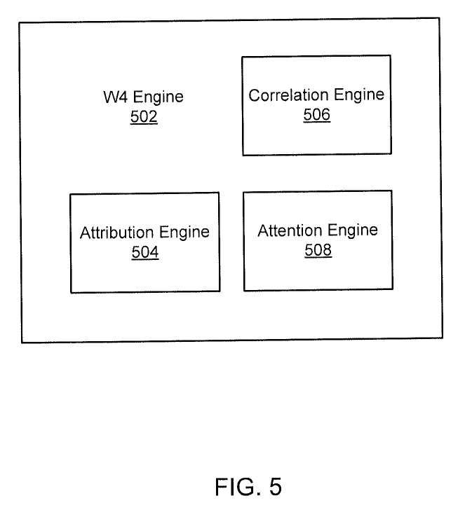

FIG. 5 illustrates one embodiment of the analysis components of a W4 engine as shown in FIG. 3. As discussed above, the W4 Engine is responsible for identifying RWEs and relationships between RWEs and IOs from the data and communication streams passing through the W4 COMN.

In one embodiment the W4 engine connects, interoperates and instruments all network participants through a series of sub-engines that perform different operations in the entity extraction process. The attribution engine 504 tracks the real-world ownership, control, publishing or other conditional rights of any RWE in any IO. Whenever a new IO is detected by the W4 engine 502, e.g., through creation or transmission of a new message, a new transaction record, a new image file, etc., ownership is assigned to the IO. The attribution engine 504 creates this ownership information and further allows this information to be determined for each IO known to the W4 COMN.

The correlation engine 506 can operates two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source.

In one embodiment, the identification of associated RWEs and IOs function of the correlation engine 506 is done by graphing the available data, using, for example, one or more histograms. A histogram is a mapping technique that counts the number of observations that fall into various disjoint categories (i.e. bins.). By selecting each IO, RWE, and other known parameters (e.g., times, dates, locations, etc.) as different bins and mapping the available data, relationships between RWEs, IOs and the other parameters can be identified. A histogram of all RWEs and IOs is created, from which correlations based on the graph can be made.

As a pre-processor, the correlation engine 506 monitors the information provided by RWEs in order to determine if any conditions are identified that can trigger an action on the part of the W4 engine 502. For example, if a delivery condition has been associated with a message, when the correlation engine 506 determines that the condition is met, it can transmit the appropriate trigger information to the W4 engine 502 that triggers delivery of the message.

The attention engine 508 instruments all appropriate network nodes, clouds, users, applications or any combination thereof and includes close interaction with both the correlation engine 506 and the attribution engine 504.

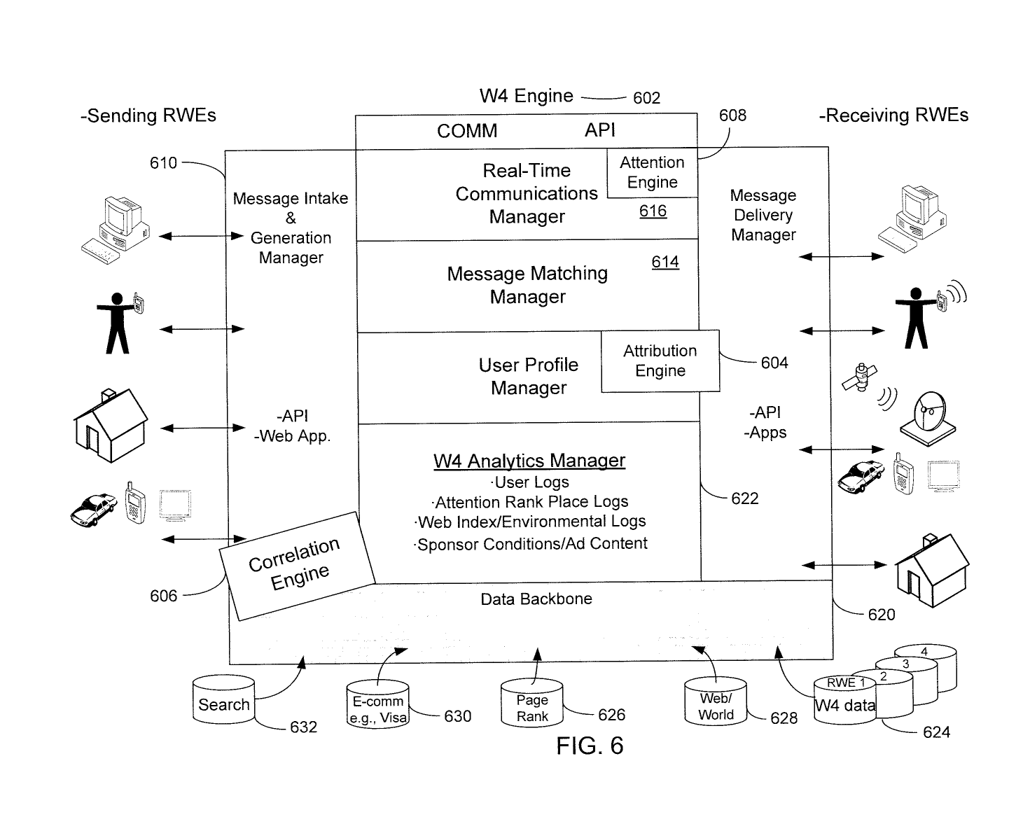

FIG. 6 illustrates one embodiment of a W4 engine showing different components within the sub-engines described above with reference to FIG. 4. In one embodiment the W4 engine 602 includes an attention engine 608, attribution engine 604 and correlation engine 606 with several sub-managers based upon basic function.

The attention engine 608 includes a message intake and generation manager 610 as well as a message delivery manager 612 that work closely with both a message matching manager 614 and a real-time communications manager 616 to deliver and instrument all communications across the W4 COMN.

The attribution engine 604 works within the user profile manager 618 and in conjunction with all other modules to identify, process/verify and represent ownership and rights information related to RWEs, IOs and combinations thereof

The correlation engine 606 dumps data from both of its channels (sensors and processes) into the same data backbone 620 which is organized and controlled by the W4 analytics manager 622. The data backbone 620 includes both aggregated and individualized archived versions of data from all network operations including user logs 624, attention rank place logs 626, web indices and environmental logs 618, e-commerce and financial transaction information 630, search indexes and logs 632, sponsor content or conditionals, ad copy and any and all other data used in any W4COMN process, IO or event. Because of the amount of data that the W4 COMN will potentially store, the data backbone 620 includes numerous database servers and datastores in communication with the W4 COMN to provide sufficient storage capacity.

The data collected by the W4 COMN includes spatial data, temporal data, RWE interaction data, IO content data (e.g., media data), and user data including explicitly-provided and deduced social and relationship data. Spatial data can be any data identifying a location associated with an RWE. For example, the spatial data can include any passively collected location data, such as cell tower data, global packet radio service (GPRS) data, global positioning service (GPS) data, WI-FI data, personal area network data, IP address data and data from other network access points, or actively collected location data, such as location data entered by the user.

Temporal data is time based data (e.g., time stamps) that relate to specific times and/or events associated with a user and/or the electronic device. For example, the temporal data can be passively collected time data (e.g., time data from a clock resident on the electronic device, or time data from a network clock), or the temporal data can be actively collected time data, such as time data entered by the user of the electronic device (e.g., a user maintained calendar).

Logical and IO data refers to the data contained by an IO as well as data associated with the IO such as creation time, owner, associated RWEs, when the IO was last accessed, the topic or subject of the IO (from message content or “re” or subject line, as some examples) etc. For example, an IO may relate to media data. Media data can include any data relating to presentable media, such as audio data, visual data, and audiovisual data. Audio data can be data relating to downloaded music, such as genre, artist, album and the like, and includes data regarding ringtones, ringbacks, media purchased, playlists, and media shared, to name a few. The visual data can be data relating to images and/or text received by the electronic device (e.g., via the Internet or other network). The visual data can be data relating to images and/or text sent from and/or captured at the electronic device.

Audiovisual data can be data associated with any videos captured at, downloaded to, or otherwise associated with the electronic device. The media data includes media presented to the user via a network, such as use of the Internet, and includes data relating to text entered and/or received by the user using the network (e.g., search terms), and interaction with the network media, such as click data (e.g., advertisement banner clicks, bookmarks, click patterns and the like). Thus, the media data can include data relating to the user's RSS feeds, subscriptions, group memberships, game services, alerts, and the like.

The media data can include non-network activity, such as image capture and/or video capture using an electronic device, such as a mobile phone. The image data can include metadata added by the user, or other data associated with the image, such as, with respect to photos, location when the photos were taken, direction of the shot, content of the shot, and time of day, to name a few. Media data can be used, for example, to deduce activities information or preferences information, such as cultural and/or buying preferences information.

Relationship data can include data relating to the relationships of an RWE or IO to another RWE or IO. For example, the relationship data can include user identity data, such as gender, age, race, name, social security number, photographs and other information associated with the user's identity. User identity information can also include e-mail addresses, login names and passwords. Relationship data can further include data identifying explicitly associated RWEs. For example, relationship data for a cell phone can indicate the user that owns the cell phone and the company that provides the service to the phone. As another example, relationship data for a smart car can identify the owner, a credit card associated with the owner for payment of electronic tolls, those users permitted to drive the car and the service station for the car.

Relationship data can also include social network data. Social network data includes data relating to any relationship that is explicitly defined by a user or other RWE, such as data relating to a user's friends, family, co-workers, business relations, and the like. Social network data can include, for example, data corresponding with a user-maintained electronic address book. Relationship data can be correlated with, for example, location data to deduce social network information, such as primary relationships (e.g., user-spouse, user-children and user-parent relationships) or other relationships (e.g., user-friends, user-co-worker, user-business associate relationships). Relationship data also can be utilized to deduce, for example, activities information.

Interaction data can be any data associated with user interaction of the electronic device, whether active or passive. Examples of interaction data include interpersonal communication data, media data, relationship data, transactional data and device interaction data, all of which are described in further detail below. Table 1, below, is a non-exhaustive list including examples of electronic data.

TABLE 1
Examples of Electronic Data

| Spatial Data | Temporal Data | Interaction Data |
|---|---|---|
| Cell tower | Time stamps | Interpersonal |
| GPRS | Local clock | communications |
| GPS | Network clock | Media |
| WiFi | User input of time | Relationships |
| Personal area network | | Transactions |
| Network access points | | Device interactions |
| User input of location | | |
| Geo-coordinates | | |

Interaction data includes communication data between any RWEs that is transferred via the W4 COMN. For example, the communication data can be data associated with an incoming or outgoing short message service (SMS) message, email message, voice call (e.g., a cell phone call, a voice over IP call), or other type of interpersonal communication related to an RWE. Communication data can be correlated with, for example, temporal data to deduce information regarding frequency of communications, including concentrated communication patterns, which can indicate user activity information.

The interaction data can also include transactional data. The transactional data can be any data associated with commercial transactions undertaken by or at the mobile electronic device, such as vendor information, financial institution information (e.g., bank information), financial account information (e.g., credit card information), merchandise information and costs/prices information, and purchase frequency information, to name a few. The transactional data can be utilized, for example, to deduce activities and preferences information. The transactional information can also be used to deduce types of devices and/or services the user owns and/or in which the user can have an interest.

The interaction data can also include device or other RWE interaction data. Such data includes both data generated by interactions between a user and a RWE on the W4 COMN and interactions between the RWE and the W4 COMN. RWE interaction data can be any data relating to an RWE's interaction with the electronic device not included in any of the above categories, such as habitual patterns associated with use of an electronic device data of other modules/applications, such as data regarding which applications are used on an electronic device and how often and when those applications are used. As described in further detail below, device interaction data can be correlated with other data to deduce information regarding user activities and patterns associated therewith. Table 2, below, is a non-exhaustive list including examples of interaction data.

TABLE 2
Examples of Interaction Data

| Type of Data | Example(s) |
|---|---|
| Interpersonal | Text-based communications, such as SMS and e- |
| communication | mail |
| data | Audio-based communications, such as voice |
| | calls, voice notes, voice mail |
| | Media-based communications, such as |
| | multimedia messaging service (MMS) |
| | communications |
| | Unique identifiers associated with a |
| | communication, such as phone numbers, e-mail |
| | addresses, and network addresses |
| Media data | Audio data, such as music data (artist, genre, |
| | track, album, etc.) |
| | Visual data, such as any text, images and video |
| | data, including Internet data, picture data, |
| | podcast data and playlist data |
| | Network interaction data, such as click patterns |
| | and channel viewing patterns |
| Relationship data | User identifying information, such as name, age, |
| | gender, race, and social security number |
| | Social network data |
| Transactional data | Vendors |
| | Financial accounts, such as credit cards and banks |
| | data |
| | Type of merchandise/services purchased |
| | Cost of purchases |
| | Inventory of purchases |
| Device interaction data | Any data not captured above dealing with user |
| | interaction of the device, such as patterns of use |
| | of the device, applications utilized, and so forth |

In general, determination of the object(s) that are sufficiently related to a reference object can be automatically identified by the W4 engine based on the density of known objects in W4 space and a predefined set of logical operators that can connect them. For example, the set of logical operators for linking objects in the Where and When dimensions can include: containing, contained in, overlapping (with temporal specializations for overlapping the beginning and overlapping the end), adjacent (with temporal specializations for adjacent to the beginning and adjacent to the end), and proximal. “When” also has the logical operator of a “period” which accounts for periodic links such as “afternoon”, “Wednesdays”, “weekends” “Spring”, etc. Media objects (or trackable people or objects) may have varying density in W4 space—some events will generate more media, some locations will be more densely populated than others, some topics will be more popular, etc.

To facilitate effective clustering and defining relatedness or nearness, the W4 engine can define a distance metric in W4 space. Distance along the Where axis can be defined as the Euclidean distance between the centroids of two areas (or more precisely, the length of the great circle segment connecting the two centroids). Distance in the When dimension can, in many cases, be defined as simply the amount of time between the midpoints of two intervals (though this can be complicated by the size of the intervals; intervals with the same midpoint are more similar if their endpoints and overall duration are more similar). Furthermore, the distance between a point in time and an interval can be defined as zero where the point in time lies within the interval. One approach to handling cyclic time is to construct a time feature vector in which the time is represented in many ways (e.g. hour of day, segment of day: morning/afternoon/evening, day of week, day of month, etc.). Matching such time vectors produces some similarity between times related only by a few features (e.g. same day of the week) and much similarity between very nearby times (times separated by an hour will match day of week, day of month, segment of day, etc.).

Furthermore, it is possible to construct a distance metric in the What dimension based on a notion of semantic distance between topics (such as using the hyponym/hypernym and holonym/meronym relationships expressed in a semantic lexicon such as WordNet.) It is similarly possible to define a social distance metric along the Who dimension based on the number of hops in a social graph between two individuals, perhaps even weighting different types of relationship (e.g., distance between siblings is less than distance between coworkers).

As to a final aggregate distance computation, defining distance over multiple dimensions can involve normalizing and/or weighting the individualy who, what, where, when distances. Given enough training data (i.e. lots of W4 data clustered or grouped into subjectively good groups), it is possible to learn weightings for graph edges and to determine some weights that allow computation of relative distance across multiple W4 dimensions.

In one particular embodiment, in order to make the task of clustering in W4 space a more tractable problem, the W4 engine can first perform clustering along each dimension individually. Within each dimension clustering can be performed in a hierarchical manner: first finding clusters with a small spread, then moving up in scale to join small clusters into larger ones. Then, the W4 engine can look across W4 dimensions for objects which appear in clusters in multiple dimensions and considering merging those clusters into a single cluster. In addition, this agglomeration across W4 dimensions can again be performed at multiple scales. Furthermore, in some cases, it may be sufficient to cluster along only the Where and When dimensions (those two dimensions often being sufficient to define an event.) The Who and What dimensions can be used primarily as filters, e.g. filtering to events attended only by a given person (Who) or concerning a particular topic (What).

### Context Enhanced Ad Creation

As discussed in more detail below, the functionality of the W4 COMN can be utilized to facilitate the creation of ads and ad campaigns. One of the most highly utilized functions of many communications and data networks is the ability for users to send messages to one another. In a particular implementation, advertisers may leverage the W4 COMN to create and deliver contextually-targeted and/or contextually-enhanced advertisements. In the implementations discussed below, an ad placement system utilizes data made available by the W4 COMN to facilitate the creation, targeting and placement of advertisements on a message delivery network, such as the W4COMN itself. Ad creation typically involves the identification of ad content, including text and media objects, as well as targeting and delivery parameters. As discussed in more detail below, implementations of the invention are directed to utilizing contextual W4 metadata to facilitate one or more aspects of ad and ad campaign creation.

The right media can evoke deep seated memories in users and create a picture, an impression, a feeling, of a time or place, a person or a group of persons, or even an abstract idea to users that evokes a call to action of some kind, commercial and/or personal. Furthermore, messaging can be further enhanced by fine-tuning the delivery of the message to correspond to a specific time or time and date. When an advertiser creates an advertisement, the advertiser may be said to have a specific context in mind for the content or delivery of the advertisement including their typical or ideal type of customer. In one embodiment, the message context can be defined as a set of criteria that describe or circumscribe one or more related ideas central to the message, the sender and the recipient in that context, and which can thus be used to create a model for message content and delivery options for that instance. The criteria can be conceptually divided into four categories: Who, What, When and Where.

“Who” criteria are persons, devices, or proxies who are related to the ideas embodied in the context. “Who” may be a known person, such as the message sender, the message recipients, or a specific person known by the user. “Who” may also be a list of specific persons, such as the contact list stored on the PDA of a user, the guest list of a party, or persons listed on a user's social network profile as friends. Alternatively, “Who” can be a general description of persons of interest, such as persons who are interested in surfing, single women in their 40's who drive motorcycles and like yoga, men who like football and commute by bus, persons who pass by a billboard more than three times a week and/or customers of a specific restaurant who also drive BMWs.

“What” criteria are objects or topics, concrete or abstract that relate to the ideas embodied in the context. “What” may be the form of media the message sender or the message recipients are interested in, such as photos, music or videos. “What” may be an object such as a car, a piece of jewelry or other object of shared interest. “What” may be a genre of music or video, such as country or rock. “What” may be subject matter addressed in media, such as love songs or even specific lyrical phrases. Alternatively, “What” may be a mood or atmosphere, such as happy, sad, energetic, or relaxed. As an indicator of topical relevance, “What” criteria are an unbounded set of things determined by human creation, attention and association or tagging.

“When” criteria are temporal constructs such as dates and times which are related to the ideas embodied in the context. “When” may be the current date and time. “When” may also be a specific date and time in the past or the future, or a range of dates and times in the past or the future, such as a duration, e.g. two hours, four weeks, one year. “When” may be a conditional occurrence if specified conditions or criteria are met. “When” may be an offset from a specific date, for example, ten days in the past, or an offset from a conditional occurrence, ten days after a mortgage payment is late. Alternatively, “When” can be an event on a calendar, such as a birthday, a season or a holiday, or an event of personal or societal/social importance, such as the last time a favorite sports team won a championship.

“Where” criteria are physical locations which are related to the ideas embodied in the context. “Where” may be a user's current location. “Where” may be specific places, such as a country, a state, a city, a neighborhood. “Where” may be defined as the location of an event, such as a concert or some other newsworthy occurrence, or alternatively the personal location of a user when they learned of an event. Alternatively, “Where” can be a general description of places of interest, such as blues or jazz clubs, or a conditional location depending on the satisfaction or resolution of specified criteria. For example, “where” can be the real-time most popular club for 24-35 year olds, or “where” can be the research lab where breast cancer is finally cured.

In one embodiment, a context-enhanced ad message comprises one or more of the following four elements: a recipient, a message body, delivery criteria, and content criteria. The recipient is one or more real world entities that are to receive the message. The recipient may be, without limitation, one or more specific persons, may be a group email address, or may be a general description of a type of recipient, such as parents of children on my child's soccer team, everyone in a person's social network, anyone meeting one or more demographic criteria, and the like.

The message body is a text or media object that expresses a specific message. For example, if a context-enhanced message is an email, the message body will typically contain some kind of text message of arbitrary length such as “Come to Joe's Falafel in Rockridge. Best Falafel in town.” The message body may include an audio file containing, for example, a voice message. The message body may include an image file containing, for example, a picture of the sender, or a video message from the user or owner of the business at the subject of the message.

Delivery criteria are the conditions under which the message is to be delivered to the recipients. Such conditions may include “Where” or spatial conditions such as, for example, when a recipient is at a specific location, within a certain proximity of a location, person or object. Such conditions may include “When” or temporal conditions such as a specific time or date or when a specific event occurs. Such criteria may also include “Who” or social criteria, such as, for example, music preferred by one or more of the sender's social network. Such criteria may also utilize “What” or topical criteria, such as, for example, when the recipient's mood as judged, for example, by the content of recent messages sent by the recipient, appears to be sad, or topical criteria indicating an activity or interest of the user.

Content criteria describe the media files that are to be included with the message. Such messages may contain criteria keyed to the recipient's or sender's context at the time the message is created and/or sent, the context of the subject of the message or the context when the message is to be delivered. Such criteria may include spatial criteria, for example, different media files are included in the message depending on the sender's or recipient's physical location at the time the message is sent or received. Such criteria may include temporal criteria, for example, different media files are included in the message depending on the time of day, the day of the week, or if it is the recipient's birthday. Such criteria may include social criteria, for example, different media files are included in the message depending on the recipient's favorite music. Content criteria may also contain any combination of criteria spatial, temporal, social or topical criteria that are unrelated to the recipient's or sender's context at the time the message is sent or delivered. For example, the message may include a criteria describing the type of media files to be delivered.

### Ad Creation

In certain implementations, an ad creation server hosts ad configuration wizard functions that facilitate the creation of ads. Based on metadata associated with the advertiser and/or the advertiser's intentions for an ad, the ad creation server can adapt an ad configuration work flow that steps the advertiser through one or more operations directed to configuring an ad and registering it for delivery in the W4 COMN. In some implementations, the ad creation server can step the advertiser through a set of configuration interfaces where input from the advertiser is solicited, such as by open fields with prompting information. Based on analysis of ad parameters and the w4 data around the ad and advertiser, for example, the ad creation server can select an ad template or modify operation of the ad template wizard to guide the advertiser through a series of prompts or input fields that are directed to creating the ad and specifying the targeting parameters for ad.

A first configuration interface may prompt the advertiser for registration or authentication information that allows for the advertiser's identity to be verified and any RWEs and IOs associated with that advertiser to be accessed. A second configuration interface can prompt the user to provide an initial set of configuration parameters for an ad. For example, a user may provide spatial parameters (such as the geographic location of a business establishment), temporal parameters (such as the operating hours of the business, or a period of time or time of day during which an offer is available), and descriptive (what) parameters that relate to the offered goods or services. The ad itself can be considered an IO that includes various attributes such as text and media objects that define the intention of the advertisement, such as an invitation to dine at a restaurant during lunch. The IO can be associated with other IOs and RWEs, such as the advertiser itself a location of the advertiser's business establishment.

The ad creation server can be configured to adapt to this initial ad configuration in a number of ways. In a first embodiment, the ad creation server can select one or more media objects from a media asset database for inclusion in the ad based on analysis of the relation of the W4 metadata associated with the media objects to the W4 metadata initially configured by the advertiser. For example, the ad creation server may select a picture of a park next to the advertiser's location, or a picture of the advertiser's location itself, as a background for the ad.

In a second embodiment, the ad creation server may auto-populate ad configuration or campaign parameters based on analysis of the initial ad configuration parameters in W4 space. For example, the ad creation server may recommend a set of targeting parameters. In one implementation, based on the W4 metadata associated with the ad, the ad creation server, in connection with the W4 engine, can provide the advertiser with knowledge of the spatio and temporal conditions, and social contexts in which the ad is likely to be delivered or should be delivered to users. For example, the W4 engine may identify the interests of various users who have been detected in locations in spatial proximity to the location associated with the ad, such as a physical location of a store. The interests of users may be deduced for example by analyzing various captured events in spatial proximity to the location of the advertiser's location. For example, when users capture digital images on a mobile device, add tags and submit them to a content aggregation site, the location of capture, the time of capture and the tags added by the user can be utilized to determine the various interests of users in proximity to the advertiser's location.

Furthermore, the time and spatial location data corresponding to various events or tracking data of individual users can be used to access user profiles that also describe user interests. In addition, the identified user profiles may be utilized to identify one or more demographic groups that are likely to be in both a desired temporal and physical proximity to the intention of the advertiser's ad. For example, the media consumption or creation activities of a user, in addition to or in lieu of explicit tracking of users, can be used to determine the number and types of users that are likely to be located near an advertiser's location, such as a restaurant, during a given time period, such as lunch or happy hour. The ad creation server can use this information to identify or recommend various targeting parameters, such as demographic attributes (e.g., males between 18 to 24), for an ad.

The ad creation server can provide a user interface for advertisers to enter ad message or campaign requests. The interface provided may be a graphical user interface displayable on mobile phones, gaming devices, computers or PDAs, including HTTP documents accessible over the Internet. Such interfaces may also take other forms, including text files, such as SMS, emails, and APIs usable by software applications located on computing devices. The interface may also provide for entry of delivery or targeting criteria that include spatial, temporal, social, or topical criteria.

In some embodiments, the ad creation process is automated by allowing advertisers to submit simple requests that the ad creation server parses to extract or identify ad configuration and delivery parameters for matching the request to an appropriate ad configuration template. For example, a request could only include a geo-location of the business and the requesting user, at which point the ad creation server retrieves W4 metadata about the user and the location in order to generate additional data for answering the request with an appropriate ad configuration template and delivery and targeting parameters as derived from data about the user and the subject location. In another example, the ad creation request may include customer data for one or more customers of the requesting advertisers such as their unique IDs, contact addresses or other personally identifiable information, and a third example request might include the requesting advertiser and one or more domains or URLs associated with the business.

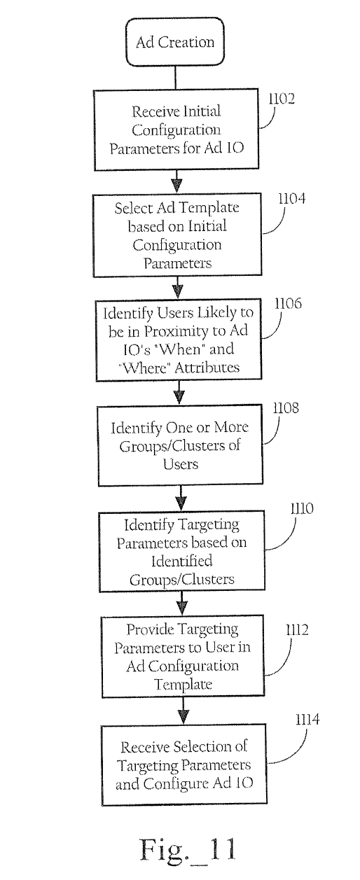

FIG. 11 illustrates a process flow executed by an ad creation server according to one possible implementation of the invention. In the implementation shown, the ad creation server receives initial configuration parameters for an ad from an advertiser (1102). The initial ad configuration parameters may include a location (such as a place of business), a temporal parameter (such as the operating hours of a business or a segment of time during which a special offer is available), and the subject of the advertisement expressed in text. The initial ad configuration parameters may also include one or more media objects, such as captured digital images and video segments, as well as one or more target parameters including demographic or other user data on actual or potential customers.

In response to the initial ad configuration parameters, the ad creation server may select an ad configuration template from a plurality of ad configuration templates (1104). In a particular implementation, an ad configuration template defines a template that facilitates configuration of ad. The template may include a structured document or message template for an ad. In addition, the ad configuration template may also include a set of configuration interfaces and workflows that step an advertiser through a series of ad configuration steps, such as the inputting and selection of user targeting parameters, the creation and/or selection of additional ad content and the like. The ad configuration template facilitates creation of ads by inclusion of these interactive instructions for generating multimedia content for one or more ads or campaigns, and may include lists of similar advertisers or potential co-marketing partners based on known or forecast sets of customers in common as well as targeting or content criteria to suggest a type, tone or theme for an ad or ad campaign based upon known or forecast customers. This information may be presented to the ad creating user through the template interface or it may simply be used in configuring the templates options. In one implementation, each ad configuration template is an IO that can be selected based on its proximity in W4 space to the ad IO initially configured by the advertiser.

Ad configuration templates may be directed towards a specific business or type of business including common small business verticals such as automotive dealership, professional service offices, e.g. doctor, dentist, attorney, a restaurant or other retail location, hotel, motel or other travel-related location as well as directed towards mobile businesses without a fixed location, e.g. sausage cart vendor.

As FIG. 11 illustrates, the ad creation server may also rely on the W4 engine to identify the recipient users that are likely to be in proximity to the ad IO's spatial (Where) attributes and the ad IO's temporal (When) attributes (1106). As discussed above, the metadata gathered by the W4 COMN can be leveraged to identify the users that are likely to be near the location of the advertiser during some desired period of time. The W4 engine can then be leveraged to analyze this set of users to identify one or more possible user groups or clusters, the common attributes of which might be useful as targeting parameters (1108). Clustering or grouping of users can be implemented along a variety of orthogonal axes both individually and in combination. Attributes that may be considered include age and gender, as well as income level, group affiliations, social connections, interests, and the like. For example, analysis of W4 metadata of the identified users might reveal that a significant number of users are teenagers attending a nearby high school or enjoy skateboarding, or that another group of users are urban professionals working in a nearby office building. From these identified clusters, one or more suggested targeting parameters may be generated by the ad creation server (1110). For example, the ad creation server may identify a targeting parameters of males between the age of 13 and 17 in connection with ad directed to a restaurant offering tacos or falafels. As FIG. 11 illustrates, the ad creation server may present the targeting parameters revealed during the clustering analysis to the advertiser (1112) in a configuration interface that allows the advertiser to explore the types of users that may be in temporal and spatial proximity to the subject of the ad and the range of possible targeting parameters that might be selected. As FIG. 11 illustrates, the ad creation server configures the ad IO for implementation on the W4 COMN when it receives confirmation of the targeting parameters from the advertiser (1114).

Other implementations are also possible. For example, ad template selection may be based in part on the groups or clusters of users identified in the analysis steps 1106-11110. For example, one ad configuration template may suggest the delivery of ad messages as short text messages in SMS form, while other ad templates may correspond to different message types. Other ad configuration templates may prompt the user to create additional content, such as to take a picture of the outside of the user's store for use in message format that supports multimedia, such as MMS or email. Still further, another ad configuration template might prompt the advertiser to create a short video segment. Such an ad configuration template might be selected if user group and clustering analysis identifies a user group, for example, that consumes large number of videos on mobile devices. In some implementations, the ad creation server may also access a database of media objects and suggest that the advertiser include one or more of the selected media objects in the ad. For example, some media assets could actually be created by users that have reviewed and recommended the restaurant, such as a short video describing the dishes the user had and what he liked.

The foregoing illustrates how W4 metadata and the W4 engine can be leveraged to facilitate ad creation. For example, based on the W4 metadata associated with the ad, the ad creation server can provide the advertiser with knowledge of the spatio and temporal conditions, as well as social contexts, according to which the ad is likely to be delivered or should be delivered to users. In addition, the ad creation server can use analysis of W4 data to recommend attributes of the ad—e.g., design attributes, media attributes. For example, as discussed above, the ad creation server can suggest enhancing ad with a short video for certain demographic groups likely to be targeted, where that demographic group has been observed to frequently consume that type of media.

### Ad Delivery

The embodiments of the present invention discussed herein illustrate application of the present invention within a W4 COMN. Nevertheless, it is understood that the invention can be implemented using any networked system, virtual or real, integrated or distributed through multiple parties, that is capable of collecting, storing accessing and/or processing user profile data, as well as temporal, spatial, topical and social data relating to users and their devices. Thus, the term W4 COMN is used herein for convenience to describe a system and/or network having the features, functions and/or components described herein throughout.

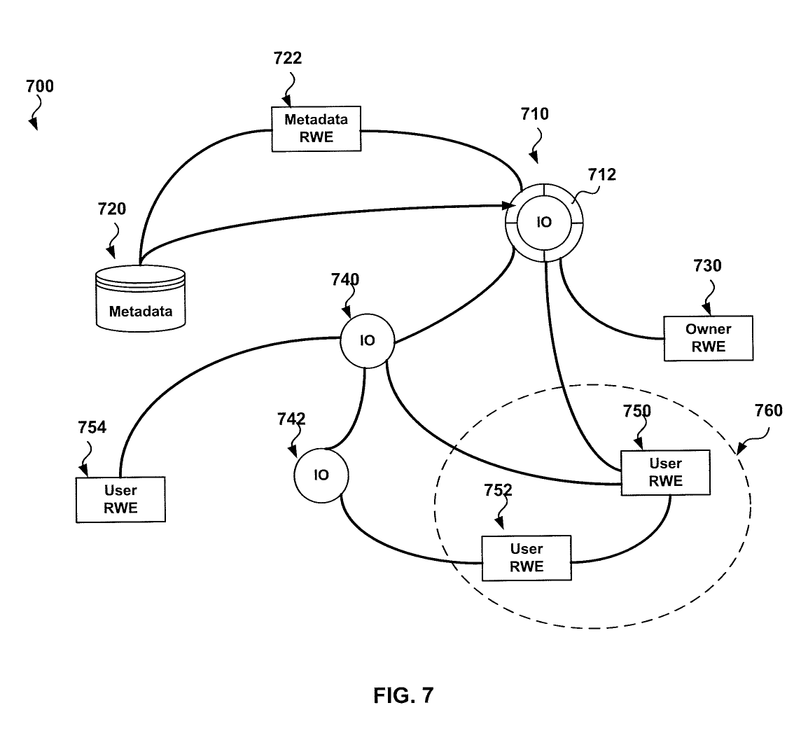

FIG. 7 illustrates one embodiment of a data model showing how a W4 COMN can store media files and relate such files to RWEs, such as persons and places, and IOs, such as topics and other types of metadata.

In the illustrated embodiment, ads are stored as media objects 710. Media objects are passive IOs relating to media files containing audio content, visual content, or both. Such media files can contain content such as songs, videos, pictures, images, audio messages, phone calls, and so forth. The media objects themselves contain metadata 712. Such data may be specific to the object data 710 and unrelated to any other IO or RWE. At the simplest level, such metadata may relate to basic file properties such as creation date, text or an image that is associated with a media file to which an IO relates. The metadata may further include delivery and targeting parameters configured during ad creation. Additionally, there are existing databases 720 which can reside within or outside of the network that can provide an extensive set of descriptive metadata relating to specific ads, videos and other types of media.

In one embodiment, metadata originating from such databases can be extracted from source databases and embedded 712 in the media objects 710 themselves. Alternatively or additionally, the media objects may be related to IOs that contain or relate to metadata 740. Metadata can include one or more keywords or topics that describe or classify data including rating or ranking information for one or more users. Alternatively or additionally, a metadata server with its associated databases can be defined as an RWE 722 within the W4 COMN, and media objects and other IOs can be associated with the RWE 722. In one embodiment, metadata relating to a media object can be retrieved on demand, rather than being stored in static metadata or in a persistent IO. Metadata retrieved on demand can be chosen based on needs of users who have a potential interest in the media object.

In one embodiment, media objects are associated with other RWEs, such as advertisers 730 (i.e. owners and licensees), and interested customers 750. In one embodiment, where an owner 730 of a media object can be identified, an attribution engine within a W4 engine tracks the real-world ownership, control, publishing or other conditional rights of any RWE in any media IO whenever a new object is detected.

In one embodiment, users 750, 752, and 754 can be identified as having an interest in a specific ad 710 or a topic IO 740 or 742 by a correlation engine within a W4 engine. In one embodiment, the correlation engine identifies relationships between user RWEs and media or IOs relating to metadata by creating a combined graph of the RWEs and IOs and their attributes, relationships and reputations. For example, a user can explicitly state in a user profile that they have an interest in a specific musical artist or type of food. Alternatively, the correlation engine can determine a user's interest in a topic or view based on the content of the user's interaction data, sensing attention events from any internal or external source including transaction history, online path and browsing history as well as physical real-world path and attention data.

In one embodiment, the W4 COMN builds a profile of a user over time by collecting data from the user or from information sources available to the network so as to gain an understanding of where they were born, where they have lived, where they live today, and where they frequently travel. Using social data, the W4 COMN can also create an overlapping social network profile which places the user in a temporal, geographic and social graph, thus determining where a user lived or worked when and with whom. User RWEs can also be associated with other RWEs through interaction data, co-location data or co-presence data. Users who are interested in the same time/place can declare their interests and be connected to a topic-based social network through, for example, an IO relating to that topic. In the illustrated embodiment in FIG. 7, users 750 and 752 are identified as being within a social network, 760.

Thus, media objects can be stored and associated with temporal, spatial, social network and topical data derived from, without limitation, traditional metadata sources, user profile data, social networks, and interaction data, building a network of relationships across the universe of media and users. Such relationships may be built on demand, if necessary, or alternatively constantly updated based upon real-time receipt of a continuous stream of data related to the user, their proxies, declared and implied interests and the rest of the real and online worlds. Such relationships can then enable queries for media that satisfy the criteria of simple or complex contexts.

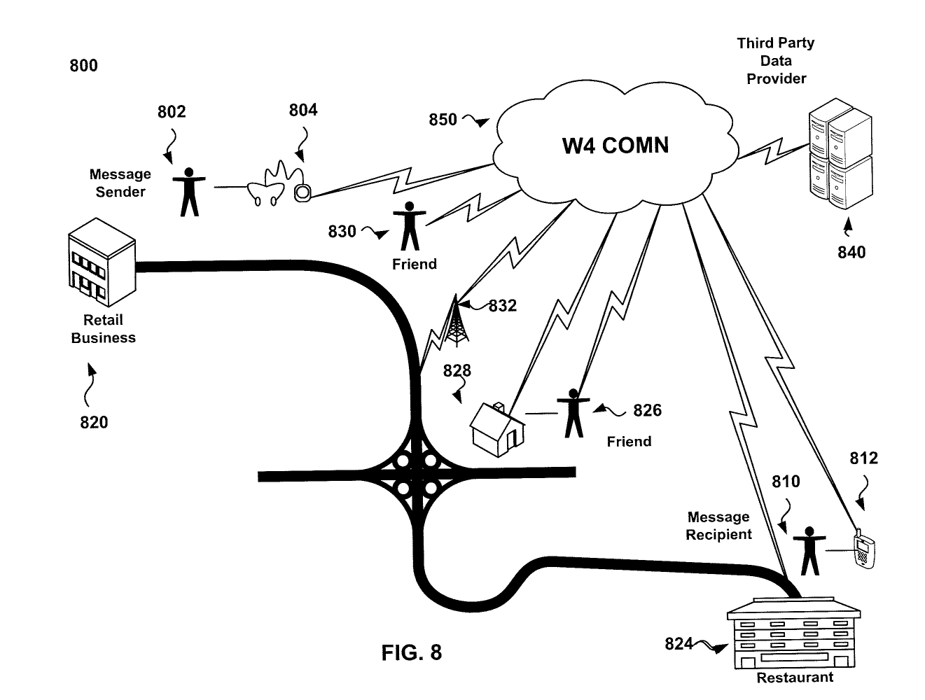

FIG. 8 illustrates one embodiment of a system 800 capable of supporting context-enhanced ad messaging between users known to a network.

The hub of the system is a W4 COMN 850 or similar network that provides data storage, processing, and real-time tracking capabilities. Within the W4 COMN are servers that provide context-based ad messaging facilities as will be described in greater detail below. The data relationships described in FIG. 7 above are stored within the W4 COMN. In one embodiment, data relationships between all real world entities and logical data are stored in a global index within the W4 COMN 850 which is maintained by processes within the W4 COMN.

Media objects may be stored by servers within the W4 COMN 850, may be stored in a distributed manner on end user devices, or may be stored by third party data providers 840, or all of the above. Third party data providers 840 may provide additional data to the network 850, such as metadata providers or social networking sites known to the network.

A message sender 802 (here, an advertiser) who wishes to send an ad message to one or more recipients configures an ad, as discussed above, including targeting and delivery criteria into a user proxy device 804 which transmits the message to the network 850. The ad message is processed by servers within the network and the ad message is delivered to the message recipient's 810 proxy device 812 under conditions satisfying the delivery and targeting criteria. Delivery conditions or parameters may be set by the advertisers including networks specifications or limitations for transmission including permissions for various channels such as cellular, wifi and Bluetooth as well as various communications channels such as email, IM, photo messaging, video chat, etc. Delivery conditions may also include geography or proximity limitations, e.g. deliver only to users within a certain range of one or more fixed or mobile locations, as well as temporal conditions, e.g. only deliver between these times, social conditions, e.g. only deliver to groups of two or more users, topical conditions, e.g. only deliver to users with a known interest in tennis, or any combination of these conditions.

Real world entities which include the message sender 802, the message recipient 810, the message sender's and message recipient's proxy devices 804 and 812 respectively, the message sender's friends 826 and 830, a retail location 820, a restaurant 824 and a friend's home 828 are known to the network. For each of the entities, the network, without limitation, tracks the physical location of the entity, builds and stores profile data and stores and analyzes interaction data. The network also receives data from remote sensors 824, which can include traffic sensors, GPS devices, weather sensors, video surveillance, cell towers, Bluetooth, Wi-Fi and so forth.

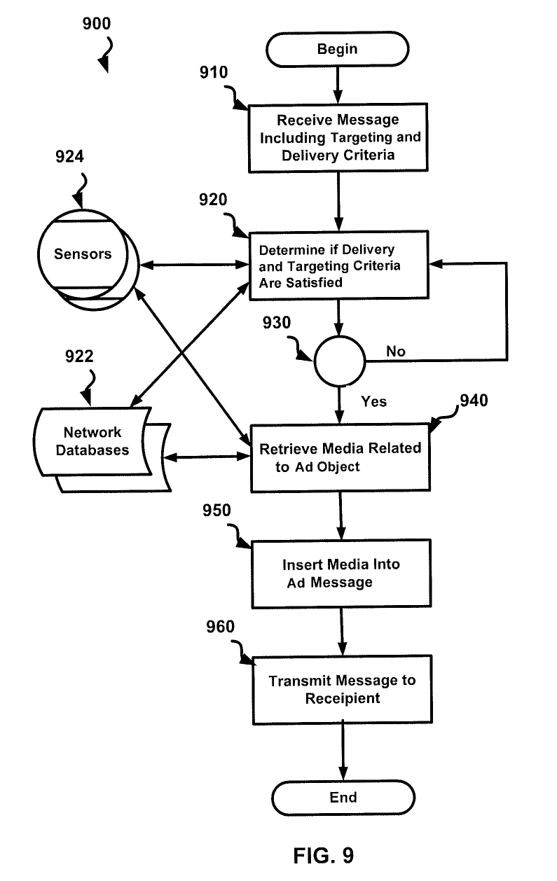

FIG. 9 illustrates one embodiment of a process of how a network containing temporal, spatial, and social network and topical data for a plurality of users, devices, and media, such as a W4 COMN, can be used to enable ad messages having complex delivery and targeting criteria.

The process begins when a message is received 910 from a message sender containing at least one recipient, and delivery criteria and content criteria. As discussed above, the message sender may enter the message, delivery and content criteria using any type of proxy device such as, for example, a portable media player, PDA, computer, or cell phone. The delivery and targeting criteria can be any combination of spatial, temporal, social or topical criteria.

In one embodiment, the criteria can be related to one another using standard relational or set operators. In one embodiment, the criteria can be stated as a natural language query. In one embodiment, criteria can be ranked in relative importance for each ad and prioritized appropriately. The request can be regarded as containing, by default, criteria which specifies the requesting user (i.e. the request is taken from the point of view of the requesting user.)

The process then determines if delivery criteria have been satisfied 920 using data available to the network, which includes network databases 922 and sensors 924. Where delivery criteria are not initially met 930, the process retains the message for a fixed length of time (such as the specified length of an ad campaign) and periodically, or continuously reevaluates delivery criteria until delivery conditions are satisfied. The process can monitor any spatial, temporal, social or topical data known to the network using databases 920 and sensors 924 available to the network.

When delivery conditions are satisfied 930, the process retrieves media, if any, related to the ad IO 940. The media files are then inserted into the ad message 950 and the message is then transmitted to one or more message recipients 960. In alternative embodiments, media files related to the content criteria can be retrieved before delivery conditions are evaluated, and the message can be updated and transmitted when delivery conditions are satisfied.

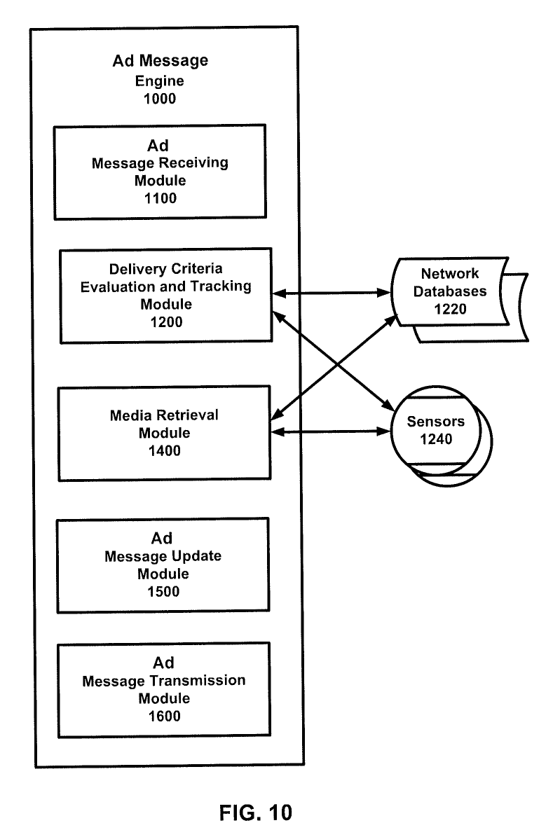

FIG. 10 illustrates one embodiment of a context enhanced message engine capable of supporting the process illustrated in FIG. 9.

An ad message engine 1000 resides on a server within the W4 COMN. The context query engine 1000 can be defined to the W4 COMN as an RWE, or alternatively, an active IO. The context query engine can be a component of a W4 engine, or, alternatively, may use services provided by components of a W4 engine or any of its constituent engines.

The ad message engine 1000 includes: an ad message receiving module 1100 that receives messages from message senders containing delivery and content criteria; a delivery criteria evaluation and tracking module 1200 that that determines if delivery and targeting criteria are satisfied and tracks data related to delivery criteria; a media retrieval module 1400 that retrieves media related to an ad; an ad message update module 1500 that inserts media files into ad messages; and an ad message transmission module 1600 that transmits the ad messages to the intended recipient(s). Any of the aforementioned modules or the communications between modules (e.g. the delivery or context criteria) can be stored on computer readable media, for transient, temporary or permanent storage.

In one embodiment, delivery and targeting criteria can be related to one another using standard relational or set operators. In one embodiment, temporal and spatial data obtained from sensors within user devices can be included in the delivery or targeting criteria. For example, the current location of a device associated with a user can be automatically identified and included in the criteria, the current time and date, etc. The ad message sender creating the context can be automatically identified through the association of the proxy device with a user within the network and automatically included in the context.

The delivery criteria evaluation and tracking module 1200 uses all data known to the network to evaluate delivery conditions. Such data may include network databases 1220 and real-time sensors 1240. Sensor data can include data relating to the physical position of any real-world entity and can include the message sender and the message recipient as well as any other known RWEs who may be specified in the delivery conditions. The end user devices may contain positioning or other sensors that detect various aspects of the physical environment surrounding the user, such as, for example, the user's geographical location, altitude and directional vector. Sensors can also include other environmental sensors such as temperature and lighting sensors, or can also include biometric sensors such as heart-rate, brain waves, etc.

As stated above, the delivery criteria may relate to any combination of spatial, temporal, social or topical data available to the network. In one embodiment, where delivery criteria are not immediately satisfied, the delivery criteria evaluation and tracking module 1200 tracks data related to the delivery criteria in the message. In one embodiment, the delivery criteria are periodically reevaluated. In another embodiment, data relating to delivery conditions are tracked in real-time, and a change in value triggers reevaluation of the delivery conditions.

For example, delivery criteria can specify that the message be processed at a future point in time, periodically, or on the occurrence of a specific event. For example, a delivery may specify that the message be reprocessed on the occurrence of a trigger condition, such as hourly, when the physical location of the entity associated with the delivery condition changes, when a calendared event occurs (e.g. an anniversary), when a news event occurs (e.g. a favorite sports team wins a game), or where a spatial, social, temporal or topical intersection occurs (e.g. when two or more friends arrive at favorite bar to watch football).

The media retrieval module 1400 searches one or more network databases 1220, for user profile data, social network data, spatial data, temporal data and topical data that is available via the network and relates to the context and to media files so as to identify at least one media file that is relevant to the content criteria. Such searches are performed using the capabilities of the network databases 1220 and their supporting infrastructure.

In one embodiment, the criteria are interpreted to take advantage of the best available data within the network. For example, if data relevant to the context resides on a relational database, the query module can execute a series of SQL statements for retrieving data from a relational database or a procedural language containing embedded SQL. Queries may be nested or otherwise constructed to retrieve data from one set of entities, and to use the result set to drive additional queries against other entities, or to use recursive data retrieval.

In the case of a W4 COMN, the content criteria can be mapped and represented against all other known entities and data objects in order to create both a micro graph for every entity as well as a global graph that relates all known entities with one another, and media objects relevant to the context are thereby identified. In one embodiment, such relationships between entities and data objects are stored in a global index within the W4 COMN.

Where query criteria relate to simple descriptive matter, such as date and time of creation, relationships can be identified using metadata embedded in media objects. Where criteria relate to a topic, such as a genre of music, relationships can be identified through IOs (whether currently existing or dynamically generated) relating to the topic which may then be used to identify media objects associated with the topic.

Where criteria relate to relationships between two or more IOs or RWEs, such as all friends of a particular user, related IOs and RWEs can be identified using social network relationships supported by the W4 COMN. When a specific media object is selected, the media search module can further determine if the message recipient or the message recipient's proxy receiving the context is permitted to access the content of the media file using ownership data in or associated with the media object.

The context enhanced message update module 1500 can update the context enhanced message in any manner that allows the message recipient to access the selected media files. In one embodiment, the actual media files are inserted into the message and open or begin playing upon opening of the enhanced message by the recipient. In one embodiment, the inserted files comprise links to the media files. In one embodiment, the media files comprise one or more playlists of multiple objects or files. In an alternative implementation, the content criteria are inserted into the message and are not evaluated until the message recipient opens the message. In one such embodiment, media retrieval module 1400 does not process the content criteria until the message recipient opens the message.

The ad message transmission module 1600 can transmit message to a single recipient or a group of recipients having a set of characteristics that define a finite set users known to the network. For example, a message may be sent to users in the sender's social network that are single and like rock music, or to fans of last night's band, who were at the show and also have their own blog.

The disclosure will now discuss specific examples of the above principles. The examples given below are intended to be illustrative, and not limiting.

In one example, if an advertiser wished to send an ad message in the form of a short video segment that automatically plays for a recipient if the user is near the advertiser's restaurant during the lunch hour, the advertiser can create an ad message having a delivery criteria of a specific time and location or proximity to location and, possibly, targeting criteria specifying demographic or other attributes of desired recipients. The delivery criteria evaluation and tracking module would track the current time and the locations of potential recipients and pass the message on to the media retrieval module for processing when the delivery and targeting conditions are met. The media retrieval module would retrieve one or more media objects for insertion into the message.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method, comprising:
receiving, over a network, an ad campaign request from a remote host, wherein the ad campaign request comprises one or more ad configuration parameters;
formulating a query based on the one or more ad configuration parameters so as to search, via the network, for an ad configuration template to facilitate creation of an ad;
serving, via the network, one or more ad configuration interfaces to the remote host in accordance with the ad configuration template that satisfied the query to generate one or more delivery and targeting parameters for the ad; and
configuring an ad delivery network to deliver the ad according to the one or more delivery and targeting parameters associated with the ad.

2. The method of claim 1 further comprising
formulating a second query based on the one or more ad configuration parameters so as to search, via the network, for user profile data, social network data, spatial data, temporal data and topical data that is available via the network and relates to the ad configuration parameters so as to identify one or more ad delivery and targeting parameters; and
inserting the one or more identified ad delivery and targeting parameters into at least one of the one or more ad configuration interfaces.

3. The method of claim 1 wherein the one or more ad configuration parameters comprises a temporal parameter defining a desired time period and a spatial parameter defining a location, and further comprising
identifying a set of users whose observed behavior satisfies the spatial and temporal parameters of the one or more ad configuration parameters; and
analyzing data associated with the set of users that is available via the network to generate one or more targeting parameters.

4. The method of claim 1 wherein the remote host is a mobile device and the ad campaign request comprises a message including text, a photo image, a video or other multimedia object.

5. The method of claim 1 wherein the ad campaign request comprises one or more geo-location parameters.

6. The method of claim 1 wherein the ad campaign request comprises one or more uniform resource locators (URLs) corresponding to remote resources hosting data for the subject of an ad campaign.

7. The method of claim 1 wherein the ad configuration template is optimized for a business type of a plurality of business types.

8. The method of claim 1 wherein the ad configuration template is operative to facilitate creation of the ad by providing interactive multimedia creation instructions.

9. The method of claim 1 wherein the one or more delivery parameters include one or more network parameter attributes.

10. A method, comprising:
receiving, over a network, an ad campaign request from a remote host, wherein the ad campaign request comprises one or more ad configuration parameters, at least a first parameter of the one or more ad configuration parameters comprising a temporal parameter and at least a second parameter of the one ad configuration parameters comprising a spatial parameter defining a location;
formulating a first query based on the temporal and spatial parameters so as to search, via the network, for user profile data, social network data, spatial data, temporal data and topical data that is available via the network and relates to the ad configuration parameters so as to identify a set of users whose observed behavior satisfies the spatial and temporal parameters of the one or more ad configuration parameters; and
analyzing data associated with the set of users that is available via the network to generate one or more targeting parameters; and
providing the one or more generated targeting parameters to the remote host.

11. The method of claim 10 further comprising
receiving, from the remote host, one or more selected targeting parameters; and
configuring the network to deliver the ad according to the one or more selected targeting parameters associated with the ad.

12. The method of claim 11 further comprising
formulating a second query based on the one or more ad configuration parameters so as to search, via the network, for an ad configuration template to facilitate creation of an ad; and
serving, via the network, one or more ad configuration interfaces to the remote host in accordance with the ad configuration template that satisfied the query to facilitate generation of the one or more delivery and targeting parameters for the ad.

13. The method of claim 10 wherein the remote host is a mobile device and the ad campaign request comprises a message including text, a photo image, a video or other multimedia object.

14. The method of claim 10 wherein the ad campaign request comprises one or more geo-location parameters.

15. The method of claim 10 wherein the ad campaign request comprises one or more uniform resource locators (URLs) corresponding to remote resources hosting data for the subject of an ad campaign.

16. The method of claim 12 wherein the ad configuration template is optimized for a business type of a plurality of business types.

17. The method of claim 12 wherein the ad configuration template is operative to facilitate creation of the ad by providing interactive multimedia creation instructions.

18. An apparatus comprising
a memory;
one or more processors;
logic encoded in one or more tangible media for execution and when executed operable to cause the one or more processors to:
receive, over a network, an ad campaign request from a remote host, wherein the ad campaign request comprises one or more ad configuration parameters;
formulate a query based on the one or more ad configuration parameters so as to search, via the network, for an ad configuration template to facilitate creation of an ad;
serve, via the network, one or more ad configuration interfaces to the remote host in accordance with the ad configuration template that satisfied the query to generate one or more delivery and targeting parameters for the ad; and
configure an ad delivery network to deliver the ad according to the one or more delivery and targeting parameters associated with the ad.

19. The apparatus of claim 18 further comprising computer-executable instructions for causing the one or more processors to
formulate a second query based on the one or more ad configuration parameters so as to search, via the network, for user profile data, social network data, spatial data, temporal data and topical data that is available via the network and relates to the ad configuration parameters so as to identify one or more ad delivery and targeting parameters; and
insert the one or more identified ad delivery and targeting parameters into at least one of the one or more ad configuration interfaces.

20. The apparatus of claim 18 wherein the one or more ad configuration parameters comprises a temporal parameter defining a desired time period and a spatial parameter defining a location, and wherein the apparatus further comprises computer-executable instructions for causing the one or more processors to
identify a set of users whose observed behavior satisfies the spatial and temporal parameters of the one or more ad configuration parameters; and
analyze data associated with the set of users that is available via the network to generate one or more targeting parameters.
